(19) United States
(12) Patent Application Publication
(10) Pub. No.: US 2009/0217543 A1
(43) Pub. Date: Sep. 3, 2009

(54) Device and Process for Selecting Products From a Range of Products, in Particular Tyre Patches

(75) Inventor: Joseph B. Casebere, Greenville, NC (US)

Correspondence Address: OLIFF & BERRIDGE, PLC, P.O. BOX 320850, ALEXANDRIA, VA, 22320-4850, US

(73) Assignee: STAHLGRUBER OTTO GRUBER GMBH & CO. KG, POING (DE)

(21) Appl. No.: 12/227,231

(22) PCT Filed: Apr. 5, 2007
(86) PCT No.: PCT/EP2007/003138

§ 371 Date: Dec. 22, 2008

(30) Foreign Application Priority Data
May 12, 2006 (DE) 10 2006 022 755.7

(51) Int. Cl. G01B 3/16; G01B 1/00

(52) U.S. Cl. 33/808

(57) ABSTRACT

The invention relates to a device for selecting products, in particular tyre patches, depending on the size of damage previously done to the tyre. For this purpose, two legs (1, 2) are connected in a rotatable manner to a hinge joint (3). The legs (1, 2) have tapering areas (4) in the area of the measuring ends. A power element (5) is positioned in such a way that the legs (1, 2) are returned to the starting position upon completion of the selection process. In the area of the measuring ends of the legs (1, 2), projections (6) are formed which are oriented in a direction of movement which corresponds to a movement separating the tapering areas (4) of the legs (1, 2). On at least one of the legs (1, 2), a display area (7) is provided in which during the selection process at least one product is selected or displayed depending on the position of the other leg (1) in the display area (7).

The present invention relates to a device and a process for selecting products from a range of products, in particular repair patches or tyre patches, depending on the geometry and the position of a damage previously done to a tyre, which makes it possible to realise an easy and cost-efficient patch/damage allocation that moreover can be quickly and safely realised.

Measuring devices for length measures in the form of commercially available calliper gauges are known from the prior art. Here, an essential functional component is a guide rail predetermining a translatory degree of freedom for the direction of movement of a carriage. A respective calliper gauge is attached to the guide rail as well as to the carriage. In this case, the movable calliper gauges can be adjusted to a certain measure, whereby distances between projections or recesses of a component or of a plurality of components can be measured.

Furthermore, an internal measuring instrument is known from patent publication DD 259 028 A1, with which grooves, punctures or the like bores on inaccessible sites within a component can preferably be gauged. To this end, the measuring legs are provided with contact pointers for feeling the dimension to be determined. One of the measuring legs is formed as an angle lever and is able to perform limited swivelling movements, the dimensional accuracy being transferred via elastic force to a dial gauge and displayed there.

If a recess were measured using the measuring apparatus known from the prior art, merely the geometric dimensions of the recess would be available as a result. During this process, measuring and reading errors may be possible error sources.

Another problem of the technical solutions known from the prior art is that during the measuring process, the measuring apparatus may easily slip which means that on the one hand measuring errors may occur and on the other hand the expenditure of time during measuring is increased due to the constant checking of the correct position.

It is the object of the present invention to provide a device and a process for selecting products from a range of products, in particular tyre patches, which allows an easy and cost-efficient patch/damage allocation and moreover can be quickly and safely realised.

The objects of the present invention are achieved according to the features of the independent claims. The dependent claims refer to advantageous examples as well as advantageous embodiments of the invention.

The device for selecting products from a range of products, in particular repair patches, may comprise at least two legs which may be connected in a rotatable manner to each other by means of a hinge joint, the legs having tapering areas in the area of measuring ends, and/or a power element which may contact the legs in such a way that it returns the legs to the starting position upon completion of the selection process, and projections which may be formed in the area of the measuring ends of the legs and may be oriented in the direction of movement of the respective leg which may correspond to a movement separating the tapered areas of the legs, and a display area which may be provided on at least one of the legs, wherein at least one product may be selected or displayed depending on the position of the other leg in the display area.

The selection device offers the advantage that the patch/damage allocation may be substantially facilitated.

It is another advantage of the device that safety during patch/damage allocation is significantly increased because the operator (tyre repairman) can only use that patch which he or she is shown on the scale and the display area, respectively, of the measuring device.

From this point of view, it is another advantage of the invention that a product can be selected which matches a recess without having to additionally measure the associated product, possibly by using another measuring instrument. Thus, the error source of measuring and reading errors during the additional product measurement is eliminated and the expenditure of time is reduced.

The present invention may also be used to select, for example, repair patches of motor lorry tyres and offers the advantage that by making small changes it may also be used for any other types and models of tyres.

As another advantage, the present invention offers protection against the device slipping during the selection process.

It is another advantage of the present invention that the device and the process are designed for selecting products from a range of products, in particular tyres, in a construction as simple and cost-efficient as possible.

Furthermore, the information of the range of products may be plotted on the display area in the form of a table.

In addition, the leg without a display area may function as an indicator pointing to information in the display area.

The projections in the area of the measuring ends of the legs may be formed such that they interlock with an inner surface of a tyre and/or an outer surface of a tyre in the area of the damage and thus allow more accurate positioning.

In another embodiment, the tapered areas in the area of the measuring ends of the legs may vary in their geometric shape depending on the damage to be measured and/or the geometry.

The distance between the two legs may vary depending on the damage to be measured and/or the geometry.

The information of the range of products may be plotted on the display area in the form of a table and in this process may be sorted vertically according to information of the product series and horizontally according to information of the product labelling.

Additionally, the information on the display area may be formed as fields in the table and/or arranged in a circular arc form.

The information on the display area which may be formed as fields in the table may include the product information of repair patches.

The illustration of the information of the range of products may be implemented in a display.

Furthermore, a storage means may be provided on which data with respect to the types of tyres may be stored in advance. The pre-stored data with respect to the repair patches may be pre-selected for indication in the display depending on the type of tyre to be measured by using a selection means. A position detection means may detect the position of the legs relative to each other and may issue a signal depending thereon. The position of the legs may be detected, for example by means of a potentiometer connected to the hinge joint 3 or by using a load cell connected to the power element 5 or by using another suitable device. An energy storage means may provide the energy needed for the operation. The information may be selected or displayed on a display corresponding in shape and size to the display area. Furthermore, a smaller display may be provided on which only one piece of product information is displayed and thus can be disposed directly on a leg.

Moreover, the leg without a display area may be an indicator and carry information with respect to the product series in a vertical direction and/or point to information in the display area.

The information which the indicator may carry in a vertical direction with respect to the product series may be arranged in a circular arc form.

The power element, which may be positioned between the legs in such a way that it returns the legs to the starting position upon completion of the selection process, may be a spiral spring.

In addition, the invention comprises a process for operating the device, wherein by compressing the legs on the side of the hinge joint facing the power element the indicator may be shifted across the display area.

By compressing the legs, the process for operating the device may press the tapering areas in the area of the measuring ends of the legs against the boundary of a recess, whereby the movement of the indicator may come to a standstill.

After the indicator comes to a standstill, the information with respect to a product labelling of a respective piece of information with respect to the product series may be directly read from the position of the indicator opposite the table in the display area.

Preferably, after the force compressing the legs has been reduced, the power element may return the legs to their starting position.

By means of the method according to the invention, repair patches may preferably be allocated to damage on a tyre.

In addition, by compressing the legs the projections formed in the area of the measuring ends of the legs may interlock with an inner surface of a tyre and/or an outer surface of a tyre and thus allow more accurate positioning.

The above-mentioned features may be randomly combined with each other in part or as a whole.

Below the invention will be explained in more detail with reference to the embodiments schematically shown in part in the drawings, wherein:

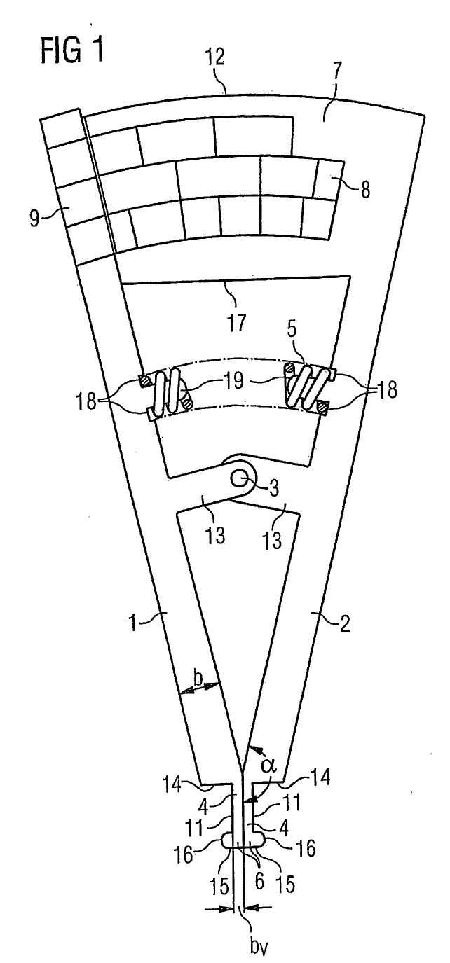

FIG. 1 shows the schematic overall structure of a device for selecting products from a range of products, in particular tyre patches,

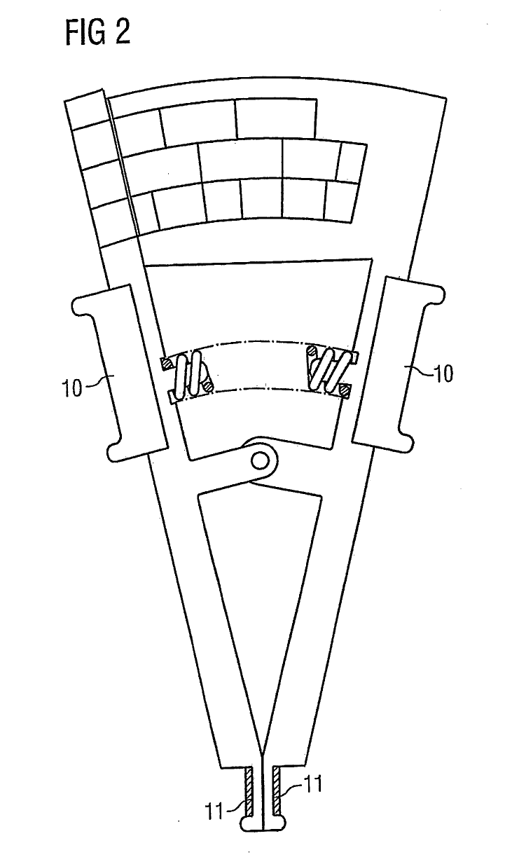

FIG. 2 shows the schematic overall structure of another advantageous embodiment of a device for selecting products from a range of products, in particular tyre patches,

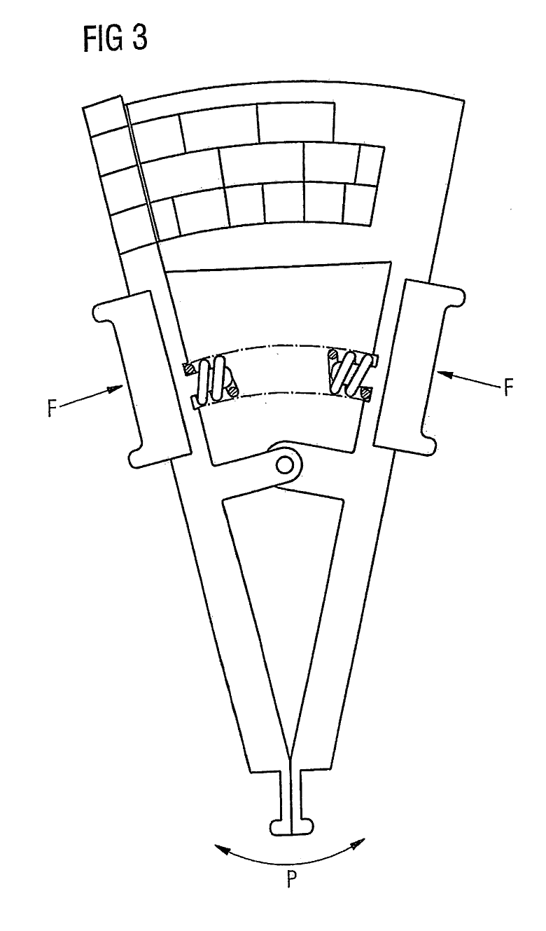

FIG. 3 shows the principal operation of the device for selecting products from a range of products, in particular tyre patches,

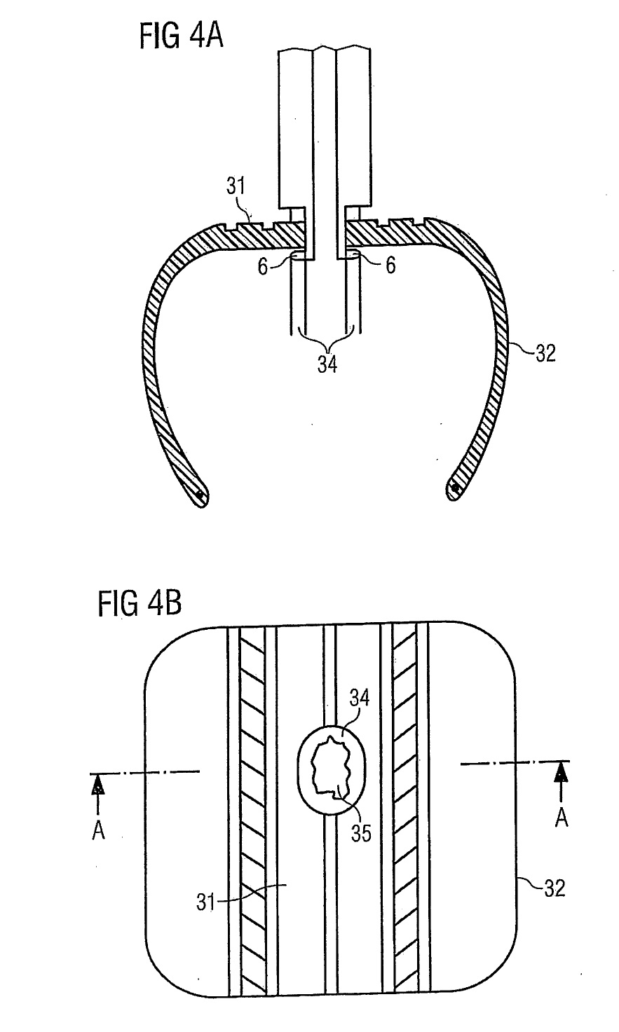

FIG. 4A shows a schematic sectional view along the cutting edge A-A in FIG. 4B illustrating a device disposed on a damage site,

FIG. 4B shows a plan view of a tyre,

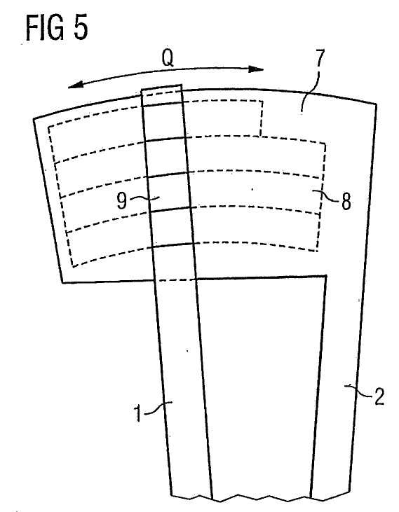

FIG. 5 shows an enlarged illustration of the display area, and

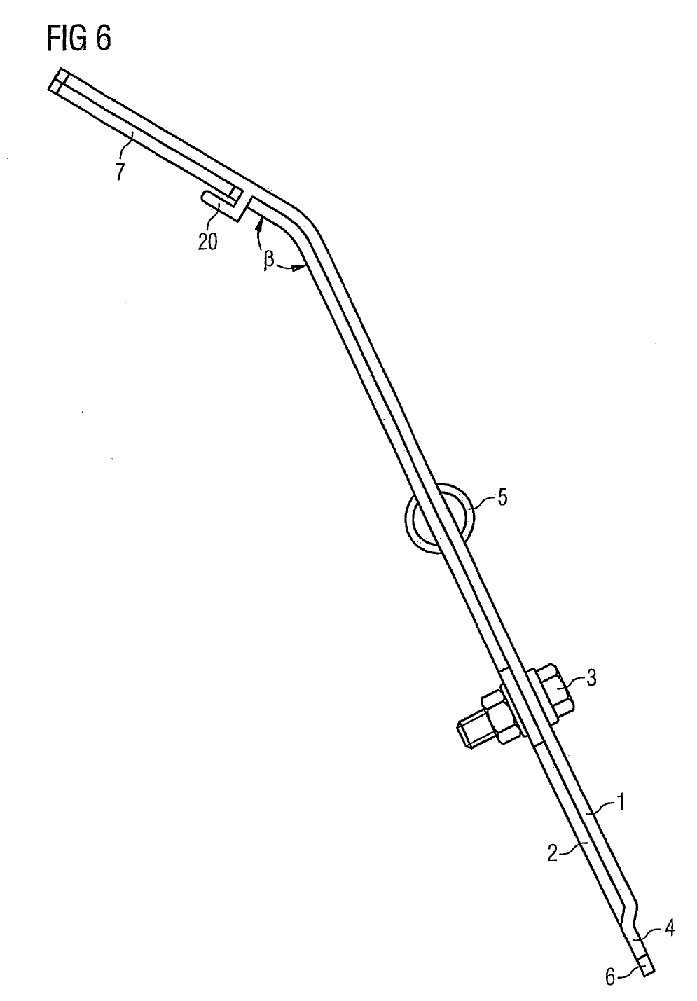

FIG. 6 shows a side view of the device.

With reference to the drawings, examples of devices according to the invention for selecting products from a range of products, in particular for selecting tyre patches, will now be schematically described.

FIG. 1 schematically shows the overall structure of a device for selecting products from a range of products, in particular tyre patches. A first leg 1 is mounted on a second leg 2 via a connecting element. Here, the connecting element fulfils the functionality of a hinge joint 3, whereby the freedom of motion of the legs is reduced to a rotatory degree of freedom.

In the present invention a screw connection is provided as connecting element 3. However, instead of the screw connection other connecting elements such as rivets, bolts or connecting elements ensuring the function of the hinge joint in a suitable manner may be provided.

The legs 1, 2 converge at an acute angle to the respective measuring ends. Instead of the geometry of the legs shown in FIG. 1 a useful parallel orientation of the legs is possible. The legs 1, 2 are formed in such a way that they have particularly high flexure strength in the direction of the effect of the power element 5. To this end, it is additionally advantageous if the legs consist of corrosion-resistant materials, such as aluminium, stainless steel, plastics or another suitable material.

The two legs 1, 2 may have tapering areas 4 at the measuring ends, which serve as measuring sensors during the selecting process. In this process, the outer surfaces of the tapering areas 4 come into contact with the boundary surface of the damage site. In the area of transition of the legs 1, 2 to the tapering areas the legs 1, 2 have an obtuse angle □ which results in parallelism between the tapering areas of the legs. The width b of the legs is reduced to the width by of the tapered areas in this area. From this results the edge 14 formed parallel to the lower edge 15 of the projections 6. In an embodiment of the selecting device, which is not shown, the edge 14 and the lower edge 15 of the projections 6 may include an angle. Furthermore, the outer surfaces 11 of the tapered areas may be coated in such a way that they have a low coefficient of static friction. Instead of the coating, a sliding element may be connected to the outer surfaces 11 of the tapered areas such that the static friction between the device for the selection of products and the damage channel is reduced. Thus, the introduction of the device for the selection of products into the damage channel can be enhanced.

Furthermore, in the area of the measuring ends of the legs 1, 2, projections 6 are formed which are oriented in the direction of movement of the respective leg 1, 2 corresponding to a movement separating the tapered areas 4 of the legs 1, 2. The projections 6 have roundings 16 at their ends which do not adjoin the tapered areas. Moreover, the projections may have an acute angle at their ends instead of the roundings 16 or they may be concluded at right angles.

Moreover, connecting lips 13 are disposed at the measuring legs, which overlap each other and function as a mounting for the hinge joint 3. The connecting lips 13 enclose a respective right angle with the legs 1, 2.

A power element 5 in the shape of a spiral spring may be disposed in such a way on the opposite side of the tapered area with respect to the hinge joint that a force is exercised the direction of effect of which corresponds to a converging movement of the tapered areas 4. In the area, in which the spiral spring comes into contact with the inner surface of the legs 1, 2, the inner surfaces of the legs 1, 2 have grooves 18 to receive each of the first and last windings of the spiral spring. Furthermore, a respective centering stub 19 is provided on each leg 1, 2 for positioning the spiral spring.

Moreover, the power element 5 may be formed as a spiral spring or disk spring or air or gas pressure spring or as a flexible deformable plastic material, for example, as an elastomer. If required, two or more power elements may of course be provided on the device and consist of a combination of the above-mentioned alternative embodiments.

A display area 7 may be formed on one of the two legs 1, 2, on which area the product information of the range of products is plotted. In this case, the display area 7 is directly shaped from one of the two legs, however, it may also be formed as an additional discrete component which is attached to one of the legs 1, 2.

Here, the upper edge 12 of the display area is designed in a circular arc form. The lower edge 17 has a rectilinear shape and encloses an acute angle with the inner surface of the leg 2 where the display area is formed. In a further embodiment of the present invention, which is not shown, the upper edge 12 and the lower edge 17 may be designed rectilinear and parallel. Furthermore, it is conceivable that the edges 12 and 17 have radii of two circular paths concentric to each other.

The leg 1 not carrying the display area 7 with the product information assumes the function of an indicator. At the end opposite the tapered areas 4 of the leg 1 designed as an indicator, information with respect to the product series 9 is plotted in the form of fields lying upon one another in a vertical direction. Here, the upper and lower edges of the fields are designed in the form of radii of two circular paths concentric to each other.

The information with respect to the product index 8, which is connected to the display area 7, may be plotted on a film, like the information with respect to the product series 9 which is plotted on the leg designed as an indicator. Furthermore, the information with respect to the product series 9 as well as the information with respect to the product index 8 may be plotted on templates connected to the display area 7 and the leg, respectively, which is formed as an indicator. In this case, the templates carry various pieces of information with respect to different repair patches, depending on the type of tyre to be repaired. By means of these templates it is possible to ensure fast and cost-efficient exchangeability of the information with respect to the product index 8, which is formed with the display area 7 and the leg, respectively, which is formed as an indicator.

In the area of the legs 1, 2, wherein the power element 5 is disposed between the legs 1, 2, a respective grip 10 may be attached to the outer surface of the legs 1, 2. Thus, it is possible to enhance the comfort during the operation of the device.

FIG. 3 illustrates the principal operation of the device for selecting products from a range of products, in particular repair patches. The tapered areas of the device are first introduced into a damage channel. Next, an operator (tyre repairman) exercises a force F on the legs 1, 2 with one hand in the area between the hinge joint 3 and the display area 7. The consequence thereof is that the measuring ends of the legs move apart from each other. The arrow P illustrates the schematic direction of movement of the projections in this process.

During a selection process, the projections 6 are dipped into the damage channel 35, e.g. on a tyre, and interlock with the inner and/or outer surface of the tyre in the area of the damage 34, as shown in FIG. 4A and FIG. 4B. Thus, the device is correctly positioned and at the same time is protected against slipping out of the damage channel. Furthermore, a tread 31 and a tyre wall 32 are shown. Although not shown in FIG. 4, the area of the damage 34 may also be on the tyre wall 32, the correct positioning being performed by the projections 6 in the same manner.

FIG. 5 shows the advantageous arrangement of the product information in a display area. Here, the product information is sorted in form of a table in a vertical direction according to a product series and in a horizontal direction according to product labelling. The information may be developed as fields in the table and arranged in a circular arc form.

During the selection process, the leg 1 formed as an indicator performs a movement relative to the display area 7, the schematic direction of movement of which is shown by the arrow Q. This movement is stopped when the outer surface of the tapered areas 4 comes into contact with the boundary surface of a damage site. It is possible to directly read the information of the product index 8 and the associated product series 9 from the resulting position of the indicator opposite the display area. In this case, the indicator carries information of the product series 9.

FIG. 6 shows the side view of the device for selecting products from a range of products, in particular tyre patches, wherein the two legs 1, 2 are tilted at an angle β to the back of the device at the height of the display area. Thus, the advantage results that the information on the display area may be read by the operator in a more comfortable manner whereby the risk of reading errors may be reduced. A safety clip 20 may be formed on the leg without a display area in such a way that a relative movement between the leg 1 formed as an indicator and the leg 2, on which the display area is provided, is limited in the axial direction of the hinge joint 3 to a maximal admissible value.

The inventive device for selecting products from a range of products offers the advantage that the patch/damage allocation can be considerably facilitated, the safety during the patch/damage allocation being significantly increased at the same time, because to the operator (tyre repair man) only the patch is pointed out which is shown to him or her on the scale and in the display area of the measuring device, respectively.

Furthermore, a product matching a recess may be directly selected without measuring the associated product additionally, possibly by using another measuring instrument. Thus, the error source of measuring and reading errors during the additional measurement of the product is eliminated and the expenditure of time is reduced.

The present invention may, for example, also be used for selecting repair patches of motor lorry tyres and offers the advantage that by making small changes it may also be used for any other types and models of tyres.

As a further advantage, the present invention offers protection against the slipping of the device during the selection process.

Another advantage of the present invention is the fact that the device for the selection of products from a range of products, in particular repair patches, is designed in a construction as simple and cost-efficient as possible.

1. A device for selecting products from a range of repair patches, comprising:
two legs connected in a rotatable manner to each other by means of a hinge joint, the legs having tapering areas in the area of measuring ends,
a power element contacting the legs in such a way that it returns the legs to the starting position upon completion of the selection process,
projections which are formed in the area of the measuring ends of the legs and oriented in the direction of movement of the respective leg, which corresponds to a movement separating the tapering areas of the legs, and
a display area provided on at least one of the legs, at least one product being selected or displayed depending on the position of the other leg in the display area.

2. The device according to claim 1, wherein:
information of the range of products is plotted on the display area in the form of a table.

3. The device according to claim 1, wherein:
the leg without a display area is an indicator pointing to information in the display area.

4. The device according to claim 1, wherein:
the projections in the area of the measuring ends of the legs are formed such that they interlock with an inner surface of a tyre and/or an outer surface of a tyre in the area of the damage and thus allow more accurate positioning.

5. The device according to claim 1, wherein:
the tapering areas in the area of the measuring ends of the legs vary in their geometric shape depending on the damage to be measured and/or the geometry.

6. The device according to claim 1, wherein:
the distance between the two legs varies depending on the damage to be measured and/or the geometry.

7. The device according to claim 1, wherein:
information of the range of products is plotted on the display area in the form of a table and in this process is sorted vertically according to information of the product series and horizontally according to information of the product labeling.

8. The device according to claim 1, wherein:
the information on the display area is formed as fields in the table which are arranged in a circular arc form.

9. The device according to claim 1, wherein:
the information on the display area is formed as fields in the table which include product information of repair patches.

10. The device according to claim 1, wherein:
the illustration of the information of the range of products is implemented in a display on the display area.

11. The device according to claim 1, wherein:
the leg without a display area is an indicator carrying information with respect to the product series in a vertical direction and pointing to information in the display area.

12. The device according to claim 1, wherein:
the information carried by the indicator in a vertical direction with respect to the product series is arranged in a circular arc form.

13. The device according to claim 1, wherein:
the power element is a spiral spring.

14. A process for selecting products from a range of repair patches, comprising a device according to claim 1, wherein:
by compressing the legs on the side of the hinge joint facing the power element an indicator is shifted across the display area.

15. The process according to claim 14, wherein:
by compressing the legs the tapering areas in the area of the measuring ends of the legs are pressed against the boundary of a recess and thus the movement of the indicator comes to a standstill.

16. The process according to claim 14, wherein:
after the indicator comes to a standstill, the information with respect to a product labeling of a respective piece of information with respect to the product series can directly be read from the position of the indicator opposite the table in the display area.

17. The process according to claim 14, wherein:
after the force compressing the legs has been reduced, the power element returns the legs to their starting position.

18. The process according to claim 14, wherein:
repair patches are assigned to a damage.

19. The process according to claim 14, wherein:
by compressing the legs the projections formed in the area of the measuring ends of the legs interlock with an inner surface of a tyre and/or an outer surface of a tyre and thus allow more accurate positioning.

20. A device for selecting products from a range of repair patches, comprising:
two legs connected in a rotatable manner to each other by means of a hinge joint,
a power element contacting the legs in such a way that it returns the legs to the starting position upon completion of the selection process,
projections which are formed in the area of the measuring ends of the legs and oriented in the direction of movement of the respective leg, which corresponds to a movement separating the tapered areas of the legs, and
a display area provided on at least one of the legs, at least one product being selected or displayed depending on the position of the other leg in the display area.

21. A device for selecting products from a range of repair patches, comprising:
two legs connected in a rotatable manner to each other by means of a hinge joint, the legs having tapering areas in the area of measuring ends,
a power element contacting the legs in such a way that it returns the legs to the starting position upon completion of the selection process, and
a display area provided on at least one of the legs, at least one product being selected or displayed depending on the position of the other leg in the display area.

22. A device for selecting products from a range of repair patches, comprising:
two legs connected in a rotatable manner to each other by means of a hinge joint,
a power element contacting the legs in such a way that it returns the legs to the starting position upon completion of the selection process, and
a display area provided on at least one of the legs, at least one product being selected or displayed depending on the position of the other leg in the display area.

23. A device for selecting products from a range of repair patches, comprising:
two legs connected in a rotatable manner to each other by means of a hinge joint, the legs having tapering areas in the area of measuring ends,
a power element contacting the legs in such a way that it returns the legs to the starting position upon completion of the selection process,
projections which are formed in the area of the measuring ends of the legs and oriented in the direction of movement of the respective leg, which corresponds to a movement separating the tapered areas of the legs, and
a display area provided on at least one of the legs, at least one product being selected or displayed depending on the position of the other leg in the display area, wherein:
information of the range of products is plotted on the display area in the form of a table.

24. A device for selecting products from a range of repair patches, comprising:
two legs connected in a rotatable manner to each other by means of a hinge joint, the legs having tapering areas in the area of measuring ends,
a power element contacting the legs in such a way that it returns the legs to the starting position upon completion of the selection process,
projections which are formed in the area of the measuring ends of the legs and oriented in the direction of movement of the respective leg, which corresponds to a movement separating the tapered areas of the legs, and
a display area provided on at least one of the legs, at least one product being selected or displayed depending on the position of the other leg in the display area, wherein:
the leg without a display area is an indicator pointing to information in the display area.

25. A device for selecting products from a range of repair patches, comprising:
two legs connected in a rotatable manner to each other by means of a hinge joint, the legs having tapering areas in the area of measuring ends,
a power element contacting the legs in such a way that it returns the legs to the starting position upon completion of the selection process,
projections which are formed in the area of the measuring ends of the legs and oriented in the direction of movement of the respective leg, which corresponds to a movement separating the tapered areas of the legs, and
a display area provided on at least one of the legs, at least one product being selected or displayed depending on the position of the other leg in the display area, wherein:
the projections in the area of the measuring ends of the legs are formed such that they interlock in the area of the damage with an inner surface of a tyre and/or an outer surface of a tyre and thus allow more accurate positioning.

26. A device for selecting products from a range of repair patches, comprising:
two legs connected in a rotatable manner to each other by means of a hinge joint, the legs having tapering areas in the area of measuring ends,
a power element contacting the legs in such a way that it returns the legs to the starting position upon completion of the selection process,
projections which are formed in the area of the measuring ends of the legs and oriented in the direction of movement of the respective leg, which corresponds to a movement separating the tapered areas of the legs, and
a display area provided on at least one of the legs, at least one product being selected or displayed depending on the position of the other leg in the display area, wherein:
information of the range of products is plotted on the display area in the form of a table and in this process is sorted vertically according to information of the product series and horizontally according to information of the product labeling.

27. A device for selecting products from a range of repair patches, comprising:
two legs connected in a rotatable manner to each other by means of a hinge joint, the legs having tapering areas in the area of measuring ends,
a power element contacting the legs in such a way that it returns the legs to the starting position upon completion of the selection process,
projections which are formed in the area of the measuring ends of the legs and oriented in the direction of movement of the respective leg, which corresponds to a movement separating the tapered areas of the legs, and
a display area provided on at least one of the legs, at least one product being selected or displayed depending on the position of the other leg in the display area, wherein:
the information on the display area is formed in the table as fields which are arranged in a circular arc form.

28. A device for selecting products from a range of repair patches, comprising:
two legs connected in a rotatable manner to each other by means of a hinge joint, the legs having tapering areas in the area of measuring ends,
a power element contacting the legs in such a way that it returns the legs to the starting position upon completion of the selection process,
projections which are formed in the area of the measuring ends of the legs and oriented in the direction of movement of the respective leg, which corresponds to a movement separating the tapered areas of the legs, and
a display area provided on at least one of the legs, at least one product being selected or displayed depending on the position of the other leg in the display area, wherein:
information of the range of products is plotted on the display area in the form of a table and in this process is sorted vertically according to information of the product series and horizontally according to information of the product labeling,
the information on the display area being formed in the table as fields which are arranged in a circular arc form.

29. A device for selecting products from a range of repair patches, comprising:
two legs connected in a rotatable manner to each other by means of a hinge joint, the legs having tapering areas in the area of measuring ends,
a power element contacting the legs in such a way that it returns the legs to the starting position upon completion of the selection process,
projections which are formed in the area of the measuring ends of the legs and oriented in the direction of movement of the respective leg, which corresponds to a movement separating the tapered areas of the legs, and
a display area provided on at least one of the legs, at least one product being selected or displayed depending on the position of the other leg in the display area, wherein:
the illustration of the information of the range of products is made in a display on the display area.

30. A device for selecting products from a range of repair patches, comprising:
two legs connected in a rotatable manner to each other by means of a hinge joint, the legs having tapering areas in the area of measuring ends,
a power element contacting the legs in such a way that it returns the legs to the starting position upon completion of the selection process,
projections which are formed in the area of the measuring ends of the legs and oriented in the direction of movement of the respective leg, which corresponds to a movement separating the tapering areas of the legs, and
a display area provided on at least one of the legs, at least one product being selected or displayed depending on the position of the other leg in the display area, wherein:
the leg without a display area is an indicator carrying information with respect to the product series in vertical direction and pointing to information in the display area.

31. A device for selecting products from a range of repair patches, comprising:
two legs connected in a rotatable manner to each other by means of a hinge joint, the legs having tapering areas in the area of measuring ends,
a power element contacting the legs in such a way that it returns the legs to the starting position upon completion of the selection process,
projections which are formed in the area of the measuring ends of the legs and oriented in the direction of movement of the respective leg, which corresponds to a movement separating the tapered areas of the legs, and
a display area provided on at least one of the legs, at least one product being selected or displayed depending on the position of the other leg in the display area, wherein:
the information which the indicator carries in a vertical direction with respect to the product series is arranged in a circular arc form.

32. A device for selecting products from a range of repair patches, comprising:
two legs connected in a rotatable manner to each other by means of a hinge joint, the legs having tapering areas in the area of measuring ends,
a power element contacting the legs in such a way that it returns the legs to the starting position upon completion of the selection process,
projections which are formed in the area of the measuring ends of the legs and oriented in the direction of movement of the respective leg, which corresponds to a movement separating the tapered areas of the legs, and
a display area provided on at least one of the legs, at least one product being selected or displayed depending on the position of the other leg in the display area, wherein:
the leg without a display area is an indicator carrying information with respect to the product series in a vertical direction and pointing to information in the display area,
the information carried by the indicator in a vertical direction with respect to the product series being arranged in a circular arc form.

33. A device for selecting products from a range of repair patches, comprising:
two legs connected in a rotatable manner to each other by means of a hinge joint, the legs having tapering areas in the area of measuring ends,
a power element contacting the legs in such a way that it returns the legs to the starting position upon completion of the selection process,
projections which are formed in the area of the measuring ends of the legs and oriented in the direction of movement of the respective leg, which corresponds to a movement separating the tapered areas of the legs, and
a display area provided on at least one of the legs, at least one product being selected or displayed depending on the position of the other leg in the display area, wherein:
information of the range of products is plotted on the display area in the form of a table and in this process is sorted vertically according to information of the product series and horizontally according to information of the product labeling,
the information on the display area in the table being formed as fields which are arranged in a circular arc form,
and/or the leg without a display area being an indicator carrying information with respect to the product series in a vertical direction and pointing to information in the display area,
the information carried by the indicator in a vertical direction with respect to the product series being arranged in a circular arc form.

34. A process for selecting products from a range of repair patches, comprising a device according to claim 1, wherein:
by compressing the legs on the side of the hinge joint facing the power element an indicator is shifted across the display area,
wherein the tapering areas in the area of the measuring ends of the legs are pressed against the boundary of a recess and thus the movement of the indicator comes to a standstill,
and the projections formed in the area of the measuring ends of the legs interlock with an inner surface of a tyre and/or an outer surface of a tyre and thus allow more accurate positioning,
wherein, after the indicator comes to a standstill, the information with respect to a product labeling of a respective piece of information with respect to the product series can be directly read from the position of the indicator opposite the table in the display area,
and that after the force compressing the legs has been reduced, the power element returns the legs to their starting position.

35. A process for selecting products from a range of repair patches, comprising a device according to claim 1, wherein:
by compressing the legs on the side of the hinge joint facing the power element an indicator is shifted across the display area,
wherein the tapering areas in the area of the measuring ends of the legs are pressed against the boundary of a recess and thus the movement of the indicator comes to a standstill.
